(19) United States
(12) Patent Application Publication
(10) Pub. No.: US 2024/0394161 A1
(43) Pub. Date: Nov. 28, 2024

(54) METHOD FOR TESTING STABILITY AND ELECTRONIC DEVICE

(71) Applicant: Fulian Precision Electronics (Tianjin) Co., LTD., Tianjin (CN)

(72) Inventors: TENG-FEI MA, Tianjin (CN); JIE YUAN, Tianjin (CN)

(21) Appl. No.: 18/507,331

(22) Filed: Nov. 13, 2023

(30) Foreign Application Priority Data
May 26, 2023 (CN) 202310610033.7

(51) Int. Cl. G06F 11/22

(52) U.S. Cl. CPC G06F 11/2284; G06F 11/2236

(57) ABSTRACT

The present disclosure relates to a testing technology field, in particular, relates to a method for testing stability and an electronic device. The method includes: in response to a testing start operation instruction triggered by a user, controlling a relay of a testing circuit of the server switch to perform a power-off operation and a power-on operation; after completing the power-off operation and the power-on operation by the relay, sending a testing instruction to the server switch; in response to the testing instruction, receiving testing data returned by the server switch, and executing a testing task according to the testing data, and obtaining a testing result. The present disclosure is able to achieve independent and out of band stability testing of server switches, greatly saving labor and time costs, and improving testing efficiency.

### CROSS-REFERENCE TO RELATED APPLICATIONS

This application claims priority to Chinese Patent Application No. 202310610033.7 filed on May 26, 2023, in China National Intellectual Property Administration, the contents of which are incorporated by reference herein.

### FIELD

The subject matter herein generally relates to a testing technology field, in particular, relates to a method for testing stability and an electronic device.

### BACKGROUND

A method for testing alternating current cycle (AC-cycle) stability is a commonly used server hardware testing method, which aims to simulate power-off and power-on situations in real-world usage environments, and check the server's response capabilities, failure rates, and long-lasting operating capabilities. A reliability and an availability of the server can be determined by the method for testing the AC-cycle stability to ensure that the server will not fail or have other problems during a long-term stable operation, thereby ensuring business continuity and data security.

A server switch refers to an image processor (e.g., a Graphics Processing Unit (GPU)) extension tool of the server. Through testing the AC-cycle stability of the server switch, it can ensure that an application program can run on reliable and efficient hardware, and it is helpful to identify server performance bottlenecks and potential problems.

However, an existing method for testing the AC-cycle stability test for the server switch is realized by testing the whole server, a testing cycle is long, and in most cases, the server is manually operated to start and shut down in a cycle, and a written testing script is used to check working status of the server after each startup of the server to determine the working status of the server switch. The above process is cumbersome and time-consuming, resulting in low test efficiency.

### BRIEF DESCRIPTION OF THE DRAWINGS

Implementations of the present disclosure will now be described, by way of embodiment, with reference to the attached figures.

FIG. 1 is a running environment diagram illustrating a testing device according to an embodiment of the present disclosure.

FIG. 2 is a running environment schematic diagram illustrating a testing device according to another embodiment of the present disclosure.

FIG. 3 is a flowchart illustrating a method for testing stability according to an embodiment of the present disclosure.

FIG. 4 is another flowchart illustrating the method for testing stability according to an embodiment of the present disclosure.

FIG. 5 is a schematic flowchart illustrating a detailed method for testing stability according to an embodiment of the present disclosure.

FIG. 6 is a structural diagram illustrating a scanning device according to an embodiment of the present disclosure.

FIG. 7 is a structural diagram illustrating an electronic device according to an embodiment of the present disclosure.

### DETAILED DESCRIPTION

The following part will clearly and completely describe technical solutions in the embodiments of the present application with reference to the drawings in the embodiments of the present application. Obviously, the described embodiments are part of the embodiments of the present application, not all of them. Based on the embodiments in the application, all other embodiments obtained by persons of ordinary skill in the art without creative work belong to the scope of protection of the application.

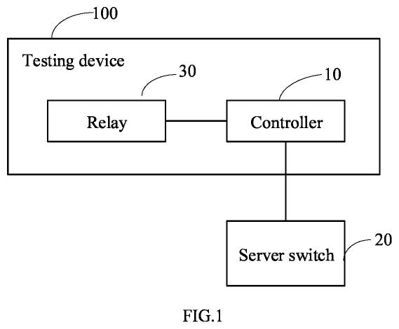

FIG. 1 illustrates a running environment diagram of an embodiment of a method for testing stability. The method is applied in a testing device 100. As shown in FIG. 1, the testing device 100 includes a controller 10, a relay 30 and a testing circuit (not shown in FIG. 1). The controller 10 and the relay 30 are connected in communication, and are located in the testing circuit. The controller 10 turns on or off the relay 30 by outputting a high level or a low level signal, so as to control an on-off of the testing circuit. The controller 10 communicates with the server switch 20, and the server switch 20 is located in the testing circuit. During a process of the controller 10 performing a stability test on the server switch 20, the controller 10 responds to a test start operation instruction triggered by the user, by turning on and off the relay 30 sequentially, the testing circuit of the server switch 20 is controlled to complete a power-off operation and a power-on operation. After the testing circuit completes the power-off operation and the power-on operation, the controller 10 sends a testing instruction to the server switch 20. The server switch 20 responds to the testing instruction and returns testing data to the controller 10. The controller 10 executes testing tasks according to the testing data received from the server switch 20. By controlling switch states of the testing circuit, multiple rounds of stability tests are performed on the server switch 20 to obtain testing results. In one embodiment, the controller 10 includes, but is not limited to any one of single-chip microcomputers, embedded chips (such as ARM Cortex chips, etc.).

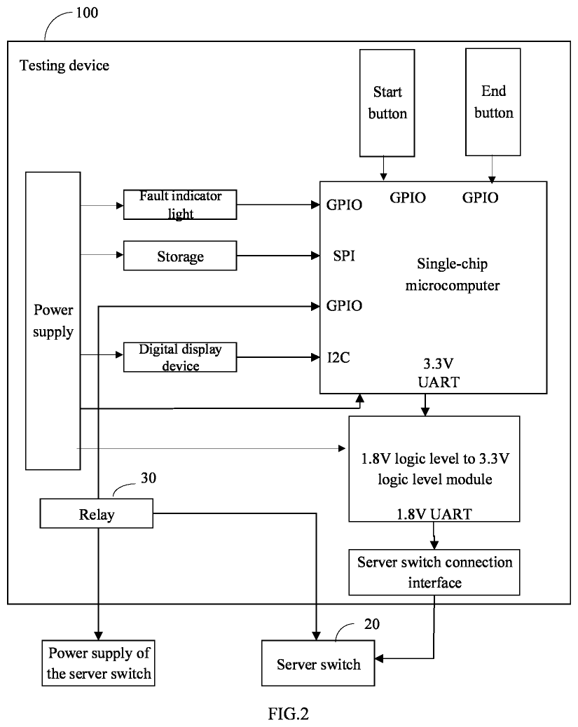

FIG. 2 illustrates a running environment schematic diagram of an embodiment of the method for testing stability. As shown in FIG. 2, taking the controller 10 as a single-chip microcomputer as an example, the testing device 100 includes a single-chip microcomputer, a start button, an end button, a fault indicator light, a storage, a relay 30, a digital display device, and a 1.8V logic level to 3.3V logic level module, a server switch connection interface. The microcontroller communicates with the server switch 20 by a universal asynchronous receiver/transmitter (UART) port. In one embodiment, as a logic level of 3.3V UART port of the single-chip microcomputer is different from a 1.8V logic level of the connection interface of the server switch 20, the testing device 100 adds a 1.8V logic level to 3.3V logic level module between the single-chip microcomputer and the server switch 20 to realize a communication between the single-chip microcomputer of different levels and the server switch 20. In one embodiment, the single-chip microcomputer also includes multiple general-purpose input/output (GPIO) interfaces, serial peripheral interface (SPI) interfaces, and inter-integrated circuit (I2C) interfaces. In one embodiment, the start key, the end key, the fault indicator light, and the relay 30 are connected to the GPIO interface of the single-chip microcomputer, the memory is connected to the SPI interface of the single-chip microcomputer, and the digital display device is connected to the I2C interface of the single-chip microcomputer. In one embodiment, the testing device 100 also includes a power supply. The power supply is connected to the fault indicator light, the storage, the digital display device, the single-chip microcomputer, and the 1.8V logic level to 3.3V logic level module for ensure a normal operation of the testing circuit. In one embodiment, the relay 30 is also connected to the power supply of the server switch 20, and the server switch 20 respectively. The single-chip microcomputer controls an on-off of the power supply of the server switch by controlling the on-off of the relay 30, thereby controlling the on-off of the server switch 20 to simulate an alternating current (AC) on-off test environment of the server switch 20, and to test the stability of the server switch 20. In one embodiment, the single-chip microcomputer can be a STM32F103C8T6 single-chip microcomputer, and the storage can be a micro flash memory card, and the digital display device can be an LED prompt light or a liquid crystal display, and the power supply of the server switch can be a 220V AC power supply.

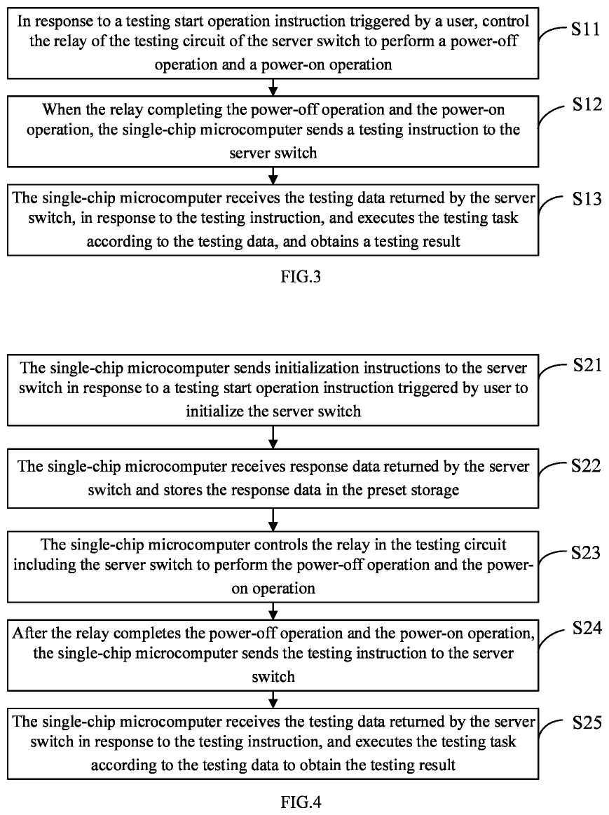

FIG. 3 illustrates a flowchart of an embodiment of the method for testing stability. The method applied in the single-chip microcomputer in FIG. 2 is taken as an example to illustrate. The method includes following steps.

At block S11, in response to a testing start operation instruction triggered by a user, control the relay of the testing circuit of the server switch to perform a power-off operation and a power-on operation.

In one embodiment, the testing device defines a start button and an end button, and the start button and the end button are communicated with the single-chip microcomputer. The user triggers the start button, and an electrical signal is the generated and input to the GPIO interface of the single-chip microcomputer by a button switch circuit. In one embodiment, the user may be a tester who implements a stability testing scheme. When detecting a level change of the GPIO interface, the single-chip microcomputer executes a corresponding interrupt service program. The interrupt service program reads a state of the GPIO interface and determines whether the start button is triggered. When the single-chip microcomputer determines that the start button is triggered, the interrupt service program starts the testing start operation instruction, and starts a test main program to perform a stability test.

In related technical solution, in order to realize the AC-cycle stability test of the server switch, the server switch is usually powered off and powered on by manually plugging and unplugging the power supply, which is a cumbersome and time-consuming process. In present application, the power-off and power-on functions are realized by controlling the switch state of the relay by the single-chip microcomputer, which effectively saves time and labor costs and improves a test efficiency.

In one embodiment, in a process of the single-chip microcomputer realizing power-off and power-on functions by controlling the relay, when the single-chip microcomputer outputs a high level, the relay is turned on, and the testing circuit is powered on; when the single-chip microcomputer outputs a low level, the relay is turned off, and the testing circuit is powered on. In one embodiment, in order to ensure the reliability and safety of the single-chip microcomputer control, circuit protection and stabilization elements can also be added to the testing equipment, such as voltage stabilizers, overvoltage protection circuit, etc.

In one embodiment, in order to ensure a normal and stable operation of a testing process, the single-chip microcomputer responds to the test start operation instruction triggered by the user, and the single-chip microcomputer sends protocol data to the server switch to configure a connection interface of the server switch, such as configuring port numbers.

At block S12, when the relay completing the power-off operation and the power-on operation, the single-chip microcomputer sends a testing instruction to the server switch.

In one embodiment, the testing instruction is an instruction to request the server switch to return the testing data. The testing instruction includes identification of operating parameters to be tested, and the like. The operating parameters to be tested include, but are not limited to an operating speed, and a protocol bandwidth.

In one embodiment, when the single-chip microcomputer controls the relay to complete the power-off operation and the power-on operation, the single-chip microcomputer sends the testing instruction to the server switch to obtain the operating parameters of the server switch after the power-off operation and the power-on operation being performed on the server switch, such as the operating speed, the protocol bandwidth, etc., and by detecting the operating parameters to be tested, the stability test of the server switch is realized.

In one embodiment, the single-chip microcomputer performs a data interaction with the server switch through a serial port, such as a UART port, and sends the testing instruction to the server switch.

In one embodiment, sending the testing instruction to the server switch, includes: detecting a communication connection status between the controller and the server switch; when the communication connection status is a normal connection status, sending the testing instruction to the server switch; when the communication connection status is an abnormal connection status, returning to a step of detecting the communication connection status between the controller and the server switch.

In one embodiment, when the server switch has performed the power-off operation and the power-on operation, the single-chip microcomputer and the server switch may not be able to establish the normal communication connection due to problems, such as a server switch connection interface failure, a single-chip microcomputer program exception, a server switch hardware failure, etc. As a result, the single-chip microcomputer is not able to send the testing instruction to the server switch, or receive the testing data returned by the server switch in response to the testing instruction. Therefore, before sending the testing instruction to the server switch, the single-chip microcomputer first detects the communication connection status between the single-chip microcomputer and the server switch. If the single-chip microcomputer detects that the communication connection status with the server switch is the normal connection status, the single-chip microcomputer sends the testing instruction to the server switch. If the single-chip microcomputer detects that the communication connection status with the server switch is the abnormal connection status, then the single-chip microcomputer re-executes a detection of the communication connection status between the controller and the server switch.

In one embodiment, if the single-chip microcomputer detects that the communication connection status with the server switch is the abnormal connection status, an alarm prompt can be triggered to remind the user of the abnormal connection status between the single-chip microcomputer and the server switch. In one embodiment, the alarm prompt includes but is not limited to sending out sound information by a voice unit, such as speaker and flashing lights by an indicator light for alarm.

In one embodiment, the single-chip microcomputer also calculates cumulative testing cycles while detecting the communication connection status with the server switch. When the cumulative testing cycles reach a preset times threshold, and the communication connection status between the single-chip microcomputer and the server switch is still the abnormal connection status, an alarm prompt is triggered to remind the user of the abnormal connection status between the single-chip microcomputer and the server switch. In one embodiment, the alarm prompt includes but is not limited to sound/light alarm.

In one embodiment, the single-chip microcomputer can establish a connection with a control terminal by a near-field communication. For example, the single-chip microcomputer can establish a Bluetooth connection with the control terminal. In one embodiment, the control terminal includes but is not limited to any one of a smart phone, a personal computer, a tablet computer, etc.

In one embodiment, the single-chip microcomputer is able to send an alarm signal to the control terminal by the near field communication.

In one embodiment, the single-chip microcomputer detects the communication connection status the with the server switch by periodically sending a heartbeat packet to the server switch and waiting for a response from the server switch. When the single-chip microcomputer does not receive the response from the server switch within a certain period of time, it is determined that the communication connection between the single-chip microcomputer and the server is disconnected. The single-chip microcomputer is also able to detect the communication connection status with the server switch by sending a ping command to the server switch. The present application does not limit implementation manners of detecting the communication connection status between the single-chip microcomputer and the server switch.

At block S13, the single-chip microcomputer receives the testing data returned by the server switch, in response to the testing instruction, and executes the testing task according to the testing data, and obtains a testing result.

In one embodiment, the testing data includes, but is not limited to, values of the operating parameters of the server switch, such as an operating speed, values of protocol bandwidth, and the like. The testing task is used to characterize steps or sequence of testing the single-chip microcomputer according to the testing data. The testing result includes one or more combinations of the testing data, working status, and testing cycles of the server switch.

In one embodiment, the server switch receives the testing instruction sent by the single-chip microcomputer, analyzes the testing instruction, determines the identification of the operating parameters to be tested, and reads specific data corresponding to the operating parameters to be tested according to the identification of the operating parameters to be tested, that is, the testing data, such as the specific data of the operating speed and the protocol bandwidth. Then, the server switch returns the read testing data to the single-chip microcomputer. The single-chip microcomputer receives the testing data returned by the server switch, and executes the testing task according to the testing data, and performs a stability test on the server switch to obtain the testing result.

In one embodiment, when determining that the single-chip microcomputer establishes a communication connection with the control terminal, the single-chip microcomputer is able to upload the testing result to the control terminal, for remote viewing and analysis of test results.

In one embodiment, executing the testing task according to the testing data and obtaining the testing result, includes: comparing the testing data with a preset data; when the testing data is consistent with the preset data, determining the working status of the server switch as the normal working status and calculating the cumulative testing cycles; when the cumulative testing cycles is greater than or equal to the preset times threshold (preset value), determining that the testing task is completed, and obtaining a first testing result; when the cumulative testing cycles is less than the preset times threshold, returning to the step of controlling the relay in the test circuit including the server switch to perform the power-off operation and the power-on operation; when the testing data is inconsistent with the preset data, determining that the working status of the server switch is the abnormal working status and ending the testing task, and obtaining a second testing result, and the second testing result at least includes the testing data of the server switch in each round of testing.

In one embodiment, the preset data refers to preset values of the operating parameters of the server switch in the normal working status. In one embodiment, the preset data can be customized by the user according to experience or historical testing data.

In one embodiment, the single-chip microcomputer can establish a connection with the control terminal by the near-field communication. For example, the single-chip microcomputer can establish the Bluetooth connection with the control terminal, so that the user can remotely configure the preset data by the control terminal. The control terminal includes but is not limited to any of smartphones, personal computers, tablets, etc.

In one embodiment, in order to improve an accuracy of the stability test on the server switch, the single-chip microcomputer performs multiple rounds of stability tests on the server switch. In one embodiment, after receiving the testing data returned by the server switch in each round of testing, the single-chip microcomputer stores the cumulative testing cycles corresponding to the testing data in each round of testing into a preset storage. In one embodiment, the preset storage includes Micro-SD card.

In one embodiment, the preset times threshold is a user-defined testing cycles threshold. When the preset times threshold is greater than or equal to the preset times threshold, the single-chip microcomputer exits a testing program and determines that the testing task is completed. In one embodiment, since the preset data refers to the value of the operating parameters of the server switch in the normal working status, and the testing data refers to the value of the operating parameters of the server switch in a current status, when receiving the testing data returned by the server switch, the single-chip microcomputer compares the testing data with the preset data. If the single-chip microcomputer determines that the testing data is consistent with the preset data, then the single-chip microcomputer determines that the working status of the server switch is the normal working status, and calculates the cumulative testing cycles.

The single-chip microcomputer compares the cumulative testing cycles with the preset times threshold, and when determining that the cumulative testing cycles is greater than or equal to the preset times threshold, the single-chip microcomputer determines that the testing task is completed and the first test result is obtained; when determining that the cumulative testing cycles is less than the preset times threshold, the single-chip microcomputer returns to the step of controlling the relay in the test circuit including the server switch to perform the power-off operation and the power-on operation, and performs a stability test on the server switch again. When the single-chip microcomputer detects that the testing data is inconsistent with the preset data, the single-chip microcomputer determines that the working status of the server switch is the abnormal working status and ends the testing task, and obtains the second testing result.

In one embodiment, the first testing result and the second testing result can be the testing data of each round of testing, the working status of each round of testing of the server switch, the cumulative testing cycles, etc., and the second testing result includes the remaining testing cycles, abnormal data, etc. In one embodiment, the single-chip microcomputer stores the first testing result and the second testing result in the preset storage, so that the user can view and verify whether the working status of the server switch is normal, and view a reason for the abnormal working status, and find potential defects and problems, and f timely repair. The single-chip microcomputer can also send the first testing result and the second testing result to a digital display device, and display the first testing result and the second testing result by the digital display device.

In one embodiment, when determining that the testing data is consistent with the preset data, the remaining testing cycles are calculated according to the cumulative testing cycles and the preset times threshold, and the remaining testing cycles are sent to the digital display device; the digital display device is controlled to display the remaining testing cycles.

In one embodiment, the digital display device includes, but is not limited to, an LED indicator light and/or a liquid crystal display. When the single-chip computer determines that the testing data is consistent with the preset data, after calculating the cumulative testing cycles, the remaining testing cycles can be calculated by calculating a difference between the preset times threshold and the cumulative testing cycles, and the remaining test times are displayed by the digital display device, so that the user can obtain a testing progress in time.

In one embodiment, when determining that the testing data is inconsistent with the preset data, the single-chip microcomputer regards the testing data inconsistent with the preset data as abnormal data, and sends the abnormal data to the digital display device; and the digital display device is controlled to display the abnormal data.

In one embodiment, when the single-chip microcomputer determines that the testing data of the server switch is inconsistent with the data of the preset data, then the data inconsistent with the preset data in the testing data is determined as the abnormal data. For example, the operating speed in the testing data is inconsistent with a preset operating speed in the preset data, and the operating speed in the testing data is determined as the abnormal data of the server switch. When the single-chip microcomputer determines the abnormal data, the abnormal data is sent to the digital display device, and the abnormal data is displayed by the digital display device, so that the user can timely determine an abnormal location of the server switch and repair the server switch in time.

In one embodiment, the single-chip microcomputer controlling the digital display device to display the abnormal data of the server switch, includes: the single-chip microcomputer sending the abnormal data to a display register of the digital display device, and sending a display command and address information to the digital display device, the display command indicating a display position of the abnormal data, that is, indicating which nixie tube of the digital display device the abnormal data is displayed on, the address information indicating a storage location of the abnormal data in the digital display device, that is, indicating which display register of the digital display device the abnormal data is in. The digital display device receives the display command and the address information sent by the single-chip microcomputer, determines the display register corresponding to the abnormal data according to the address information, obtains the abnormal data from the display register, and displays the abnormal data on corresponding digital tube according to the display command.

In one embodiment, when determining that the testing data is inconsistent with the preset data, the fault light is triggered to indicate the abnormal data.

In one embodiment, the fault light is set in the testing device, and when the single-chip microcomputer determines that the testing data is inconsistent with the preset data, the fault light is turned on to prompt the user that the working status of the server switch is abnormal. Multiple fault lights corresponding to the operating parameters in the testing data or the preset data can also be set in the testing device. When determining that the testing data is inconsistent with the preset data, the single-chip microcomputer determines the abnormal operating parameters corresponding to the abnormal data inconsistent with the preset data in the testing data, triggers the fault light corresponding to the abnormal operation parameter, so that the user can determine the abnormal position of the server switch in time and repair the server switch in time.

In other embodiments of the present application, the testing device sets a prompt light for prompting the server switch to be in a normal working status. When the single-chip microcomputer determines that the testing data is consistent with the preset data, the single-chip microcomputer turns on the prompt light. In one embodiment, the fault light and the prompt light can be a same device. When the single-chip microcomputer is triggered to turn on the fault light, a red light is displayed, and when the single-chip microcomputer is triggered to turn on the prompt light, a green light is displayed.

In one embodiment, before responding to a user-triggered testing start operation instruction, the function initialization of the single-chip microcomputer is also performed, for example, a SPI port initialization, a UART port initialization, an idle interrupt initialization, a button trigger interrupt initialization, a file system initialization, a GPIO port initialization, etc., to make various peripherals and internal modules of the single-chip microcomputer work normally, make the single-chip microcomputer in a suitable working status, and performs required testing tasks.

In an implementation process of the method for testing stability provided in an embodiment of the present application, a testing device is provided, and the testing device includes a controller, a relay, and the like. The controller communicates with the server switch by the serial ports to test the stability of the server switch. Specifically, the controller responds to the testing start operation instruction triggered by the user, controls the relay to perform the power-off operation and the power-on operation, and simulates the on-off of the Alternating Current (AC) power supply. After completing the power-off operation and the power-on operation, the testing device sends the testing instruction to the server switch, executes the testing task according to the testing data returned by the server switch, and obtains the testing result. An independent out-of-band stability test of the server switch is realized, and after the user triggers the testing start operation instruction, the testing device realizes the stability test of the server switch by the controller, which greatly saves labor and time costs and improves test efficiency.

In other embodiments of the present application, the single-chip microcomputer may also conduct a stability test on a device or chip (Expander) used to expand hard disk channel of the server according to the above-mentioned method, which will not be repeated here.

FIG. 4 illustrates another flowchart of an embodiment of the method for testing stability. As shown in FIG. 4, the method includes the following steps.

At block S21, the single-chip microcomputer sends initialization instructions to the server switch in response to a testing start operation instruction triggered by user to initialize the server switch.

In one embodiment, the initialization instruction includes but is not limited to the testing instruction. Due to a testing of the server switch not only includes a stability testing, but also other types of testing, such as a functional testing, a performance testing, a security testing, a reliability testing, etc., in order to ensure that the server switch is in a stability testing mode or a stability testing state, the single-chip microcomputer responds to the testing start operation instruction triggered by use, by sending initialization instructions (such as testing instructions) to the server switch, initialize the server switch.

At block S22, the single-chip microcomputer receives response data returned by the server switch and stores the response data in the preset storage.

In one embodiment, the server switch receives the initialization instructions sent by the single-chip microcomputer, such as testing instructions, enters the stability testing mode, and analyzes the testing instructions to determine the identification of the operating parameters to be tested that the microcontroller needs to obtain, that is, the testing data, such as specific data on the operating speed, protocol bandwidth, etc. Then, the server switch returns the read testing data as response data to the single-chip microcomputer. The single-chip microcomputer receives the testing data returned by the server switch and stores the testing data in the preset storage, to complete the initialization of the server switch. In one embodiment, the preset storage includes Micro SD cards.

At block S23, the single-chip microcomputer controls the relay in the testing circuit including the server switch to perform the power-off operation and the power-on operation.

At block S24, after the relay completes the power-off operation and the power-on operation, the single-chip microcomputer sends the testing instruction to the server switch.

At block S25, the single-chip microcomputer receives the testing data returned by the server switch in response to the testing instruction, and executes the testing task according to the testing data to obtain the testing result.

In one embodiment, specific solutions of steps S23 to S25 can refer to the description of the specific embodiments of steps S11 to S13 in FIG. 3.

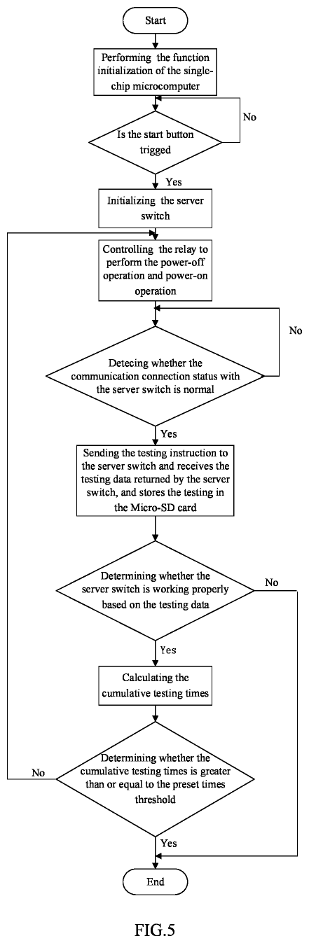

FIG. 5 illustrates a schematic flowchart of an embodiment of the method for testing stability. As shown in FIG. 5, taking the controller as the single-chip microcomputer as an example, before the user triggers the start button and starts the testing instruction, the single-chip microcomputer first performs the function initialization of the single-chip microcomputer, such as a SPI port initialization, a button triggered interrupt initialization, an idle interrupt initialization, a UART port initialization, a file system initialization, a Direct Memory Access (DMA) initialization, a GPIO port initialization, etc.

When the user triggers the start button, the testing start operation instruction is triggered, the single-chip microcomputer responds to the test start operation instruction and initializes the server switch, for example, sending a test command to the server switch and receiving the test data returned by the server switch to complete the initialization of the server switch, to make the server switch to enter stability testing mode. Then, the single-chip microcomputer controls the relay to perform the power-off operation and power-on operation, and simulates a running on-off environment of the server switch. After the relay completes the power-off operation and power-on operation, the single-chip microcomputer detects whether the communication connection status with the server switch is normal. In one embodiment, the single-chip microcomputer can determine whether the communication connection status with the server switch is normal by sending heartbeat signals or instructions to the server switch at a fixed time and checking return signals of the server switch. When the single-chip microcomputer receives a confirmation signal returned by the server switch, the single-chip microcomputer determines that the communication connection status with the server switch is the normal connection status; when the microcontroller does not receive a return signal from the server switch within a certain period of time, or receives an abnormal return signal, the single-chip microcomputer determines that the communication connection status with the server switch is the abnormal connection status. When the single-chip microcomputer determines that the communication connection status with the server switch is normal, the single-chip microcomputer sends the testing instruction to the server switch and receives the testing data returned by the server switch, and stores the testing in the Micro-SD card for users to view and analyze the testing data. After receiving the testing data of the server switch, the single-chip microcomputer determines whether the server switch is working properly based on the testing data. In one embodiment, the single-chip microcomputer compares the testing data with the preset data to determine whether the server switch is working properly. The specific implementation method can refer to the specific implementation of the step S13 in FIG. 3. If the single-chip microcontroller determines that the working status of the server switch is normal, the single-chip microcontroller calculates the cumulative testing cycles, and determines whether the cumulative testing cycles is greater than or equal to the preset times threshold. When the single-chip microcontroller detects that the cumulative testing cycles is greater than or equal to the preset times threshold, the single-chip microcontroller determines that the testing task is completed and ends the test; when the single-chip microcontroller detects that the cumulative testing cycles is less than the preset times threshold, the single-chip microcontroller returns to the steps of controlling the relay to perform the power-off operation and power-on operation, and performs the stability test on the server switch in a loop to improve the testing accuracy. When the single-chip microcontroller determines that the working status of the server switch is abnormal, the single-chip microcontroller ends the stability test. In one embodiment, when the single-chip microcontroller determines that the working status of the server switch is abnormal, the single-chip microcontroller startup a fault light to prompt the user for abnormal data.

It should be understood that a size of the sequence number of each step in the above embodiments does not imply an order of execution. The execution order of each process should be determined based on its function and internal logic, and should not constitute any restrictions on the implementation process of the embodiments.

In one embodiment, a device 600 for testing stability is provided, which corresponds one-to-one with the method for testing stability in above embodiment. As shown in FIG. 6, the device includes a control module 601, an instruction sending module 602, and a testing module 603. The detailed description of each functional module is described as follows.

The control module 601, in response to a testing start operation instruction triggered by user, controls the relay of the testing circuit of the server switch to perform a power-off operation and a power-on operation.

The instruction sending module 602 sends a testing instruction to the server switch, when the relay completing the power-off operation and the power-on operation,

The testing module 603 receives the testing data returned by the server switch, in response to the testing instruction, and executes the testing task according to the testing data, and obtains a testing result.

The specific limitations of stability testing devices can be found in the above section regarding the limitations of the method for testing stability, and will not be repeated here. The various modules in the device for testing stability mentioned above can be fully or partially implemented through software, hardware, and their combinations. The above modules can be embedded in hardware or independent of the controller in the testing device, or stored in software in the storage of the testing device, for the controller to call and execute the corresponding operations of the above modules.

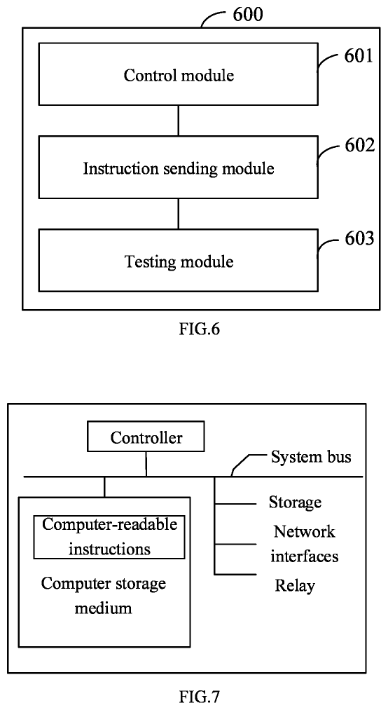

In one embodiment, the testing device is provided, and its internal structure diagram can be shown in FIG. 7. The testing device includes a controller, a storage, a relay, and network interfaces connected through system bus. In one embodiment, the controller of the testing device is used to provide computing and control capabilities. The storage of the testing device includes computer readable storage media and an internal storage. The computer storage medium stores an operating system and computer-readable instructions. This internal storage provides an environment for the operation of the operating systems and computer readable instructions in the computer readable storage media. The network interfaces of the testing device are used to communicate with external servers through a network connection. A method for testing stability is implemented when the computer-readable instructions are executed by the controller. The computer readable storage medium provided in the embodiment includes non-volatile readable storage medium and volatile readable storage medium.

In one embodiment, a testing device is provided, including a storage, a controller, a relay, and computer-readable instructions stored in the storage that can be run on the controller. When the controller executes the computer-readable instructions, the following steps are implemented: in response to a testing start operation instruction triggered by user, controlling the relay of the testing circuit of the server switch to perform a power-off operation and a power-on operation; sending a testing instruction to the server switch, when the relay completing the power-off operation and the power-on operation; receiving the testing data returned by the server switch, in response to the testing instruction, and executing the testing task according to the testing data, and obtaining a testing result.

Ordinary technical personnel in this field can understand that the implementation of all or part of the processes in the above embodiments can be completed by instructing the relevant hardware through computer-readable instructions. The computer-readable instructions can be stored in a non-volatile readable storage medium or a volatile readable storage medium, and the computer-readable instructions can include the processes in the embodiments of the above methods when executed. Any reference to memory, storage, database, or other media used in the embodiments provided in the application may include non-volatile medium and volatile medium. The non-volatile storage can include a read-only memory (ROM), a programmable ROM (PROM), an electrically programmable ROM (EPROM), an electrically erasable programmable ROM (EEPROM), or a flash memory. The volatile storage can include a random access memory (RAM) or an external cache memory. As an explanation rather than limitation, the RAM is available in various forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous link DRAM (SLDRAM), a Rambus direct RAM (RDRAM), a direct memory bus dynamic RAM (DRDRAM), and memory bus dynamic RAM (RDRAM).

The above description only represents some embodiments of the present disclosure and is not intended to limit the present disclosure, and various modifications and changes can be made to the present disclosure. Any modifications, equivalent substitutions, and improvements made within the spirit and scope of the present disclosure are intended to be included within the scope of the present disclosure.

What is claimed is:

1. A method for testing stability, applied in a controller communicated with a server switch, the method comprising:
controlling, in response to a testing start operation instruction triggered by a user, a relay of a testing circuit of the server switch to perform a power-off operation and a power-on operation;
sending a testing instruction to the server switch after completing the power-off operation and the power-on operation by the relay; and
receiving, in response to the testing instruction, testing data returned by the server switch, executing a testing task according to the testing data, and obtaining a testing result.

2. The method for testing stability as recited in claim 1, wherein executing the testing task according to the testing data, and obtaining the testing result, further comprising:
comparing the testing data with preset data;
determining, in response that the testing data is consistent with the preset data, a working status of the server switch as a normal working status and calculating a cumulative testing cycles;
determining, in response that the cumulative testing cycles is greater than or equal to a preset times threshold, that the testing task is completed, and obtaining a first testing result;
controlling, in response that the cumulative testing cycles is less than the preset times threshold, the relay in the test circuit of the server switch to perform the power-off operation and the power-on operation; and
determining, in response that the testing data is inconsistent with the preset data, that the working status of the server switch is an abnormal working status and ending the testing task, and obtaining a second testing result, the second testing result comprising at least the testing data of the server switch.

3. The method for testing stability as recited in claim 1, further comprising:
detecting a communication connection status between the controller and the server switch;
sending, in response that the communication connection status is a normal connection status, the testing instruction to the server switch; and
re-detecting, in response that the communication connection status is an abnormal connection status, the communication connection status between the controller and the server switch.

4. The method for testing stability as recited in claim 1, further comprising:
initializing, in response to the testing start operation instruction, the server switch by sending an initialization instruction to the server switch; and
receiving response data returned by the server switch and storing the response data in a preset storage.

5. The method for testing stability as recited in claim 2, further comprising:
determining, in response that the testing data is consistent with the preset data, a remaining testing cycles according to the cumulative testing cycles and the preset times threshold, and sending the remaining testing cycles to a digital display device; and
controlling the digital display device to display the remaining testing cycles.

6. The method for testing stability as recited in claim 2, further comprising:
determining, in response that the testing data is inconsistent with the preset data, the testing data that is inconsistent with the preset data as abnormal data, and sending the abnormal data to the digital display device; and
controlling the digital display device to display the abnormal data.

7. The method for testing stability as recited in claim 6, further comprising:
turning on, in response that the testing data is inconsistent with the preset data, a light to indicate the abnormal data.

8. An electronic device comprising:
a processor; and
a non-transitory storage medium, coupled to the processor, that stores a plurality of instructions, which cause the processor to:
control, in response to a testing start operation instruction triggered by a user, a relay of a testing circuit of the server switch to perform a power-off operation and a power-on operation;
send a testing instruction to the server switch after completing the power-off operation and the power-on operation by the relay;
receive, in response to the testing instruction, testing data returned by the server switch, execute a testing task according to the testing data, and obtain a testing result.

9. The electronic device as recited in claim 8, wherein the plurality of instructions is further configured to cause the processor to:
compare the testing data with preset data;
determine, in response that the testing data is consistent with the preset data, a working status of the server switch as a normal working status and calculate a cumulative testing cycles;
determine, in response that the cumulative testing cycles is greater than or equal to a preset cycles threshold, that the testing task is completed, and obtain a first testing result;
control, in response that the cumulative testing cycles is less than the preset cycles threshold, the relay in the test circuit of the server switch to perform the power-off operation and the power-on operation; and
determine, in response that the testing data is inconsistent with the preset data, that the working status of the server switch is an abnormal working status and end the testing task, and obtain a second testing result, the second testing result comprising at least the testing data of the server switch.

10. The electronic device as recited in claim 8, wherein the plurality of instructions are further configured to cause the processor to:
detect a communication connection status between the controller and the server switch;
send, in response that the communication connection status is a normal connection status, the testing instruction to the server switch; and
re-detect, in response that the communication connection status is an abnormal connection status, the communication connection status between the controller and the server switch.

11. The electronic device as recited in claim 8, wherein the plurality of instructions are further configured to cause the processor to:
initialize, in response to the testing start operation instruction, the server switch by sending an initialization instruction to the server switch; and
receive response data returned by the server switch and store the response data in a preset storage.

12. The electronic device as recited in claim 9, wherein the plurality of instructions are further configured to cause the processor to:
determine, in response that the testing data is consistent with the preset data, a remaining testing cycles according to the cumulative testing cycles and the preset times threshold, and send the remaining testing cycles to a digital display device; and
control the digital display device to display the remaining testing cycles.

13. The electronic device as recited in claim 9, wherein the plurality of instructions are further configured to cause the processor to:
determine, in response that the testing data is inconsistent with the preset data, the testing data that is inconsistent with the preset data as abnormal data, and send the abnormal data to the digital display device; and
control the digital display device to display the abnormal data.

14. The electronic device as recited in claim 13, wherein the plurality of instructions are further configured to cause the processor to:
turn on, in response that the testing data is inconsistent with the preset data, a light to indicate the abnormal data.

15. A non-transitory storage medium having stored thereon instructions that, when executed by at least one processor of an electronic device, causes the least one processor to execute instructions of a method for testing stability, the method comprising:
controlling, in response to a testing start operation instruction triggered by a user, a relay of a testing circuit of the server switch to perform a power-off operation and a power-on operation;
sending a testing instruction to the server switch after completing the power-off operation and the power-on operation by the relay; and
receiving, in response to the testing instruction, testing data returned by the server switch, executing a testing task according to the testing data, and obtaining a testing result.

16. The non-transitory storage medium as recited in claim 15, wherein the method further comprises:
comparing the testing data with preset data;
determining, in response that the testing data is consistent with the preset data, a working status of the server switch as a normal working status and calculating a cumulative testing cycles;
determining, in response that the cumulative testing cycles is greater than or equal to a preset times threshold, that the testing task is completed, and obtaining a first testing result;
controlling, in response that the cumulative testing cycles is less than the preset times threshold, the relay in the test circuit of the server switch to perform the power-off operation and the power-on operation; and
determining, in response that the testing data is inconsistent with the preset data, that the working status of the server switch is an abnormal working status and ending the testing task, and obtaining a second testing result, the second testing result comprising at least the testing data of the server switch.

17. The non-transitory storage medium as recited in claim 15, wherein the method further comprises:
detecting a communication connection status between the controller and the server switch;
sending, in response that the communication connection status is a normal connection status, the testing instruction to the server switch; and
re-detecting, in response that the communication connection status is an abnormal connection status, the communication connection status between the controller and the server switch.

18. The non-transitory storage medium as recited in claim 15, wherein the method further comprises:
initializing, in response to the testing start operation instruction, the server switch by sending an initialization instruction to the server switch; and
receiving response data returned by the server switch and storing the response data in a preset storage.

19. The non-transitory storage medium as recited in claim 16, wherein the method further comprises:
determining, in response that the testing data is consistent with the preset data, a remaining testing cycles according to the cumulative testing cycles and the preset times threshold, and sending the remaining testing cycles to a digital display device; and
controlling the digital display device to display the remaining testing cycles.

20. The non-transitory storage medium as recited in claim 16, wherein the method further comprises:
determining, in response that the testing data is inconsistent with the preset data, the testing data that is inconsistent with the preset data as abnormal data, and sending the abnormal data to the digital display device; and
controlling the digital display device to display the abnormal data.
